(19) United States
(12) Patent Application Publication
(10) Pub. No.: US 2008/0281759 A1
(43) Pub. Date: Nov. 13, 2008

(54) System and Method for Registration Control

(76) Inventors: Jesper Weissglas, Stockholm (SE); Ted Folsom, Akersberga (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/815,373

(22) PCT Filed: Feb. 2, 2006
(86) PCT No.: PCT/SE2006/000146

§ 371 Date: Jun. 17, 2008

(30) Foreign Application Priority Data
Feb. 2, 2005 (SE) 0500241-5

(51) Int. Cl. G07G 1/12; H04L 9/10

(52) U.S. Cl. 705/71; 705/75

(57) ABSTRACT

The invention concerns a control unit (12), a control system (10) and a method for the checking of transactions carried out in a cash register (11). The control unit (12) has interfaces (27, 28) for connection to at least one cash register (11) and at least one receipt writer (13), and it is characterised in that it comprises at least one regulatory unit (21) in which encryption algorithms (22) are stored, which encryption algorithms (22) are used to generate a unique code based on transaction data (24) from the cash register (11), which unique code is sent to the receipt writer (13) to be printed onto the receipt. The authenticity of all receipts that are generated by the system can in this way be subsequently checked.

### TECHNICAL AREA

The present invention concerns the check of accounting in cash registers. The invention concerns a control unit, a control system and a method for checking the transactions carried out by a cash register.

Such units, systems and methods can be used in all areas in which receipts are written, such as cash registers in restaurants, shops and petrol stations.

### BACKGROUND AND THE PRIOR ART

The use of cash registers to input prices of the goods that a customer purchases is known within the retail industry, as is their use to input the amount that the customer has paid. According to the prior art, a cash register comprises means for calculating the sum of the prices of the items, also known as the requested amount, and means for calculating the difference between the amount paid in and the requested amount.

The cash register is normally connected to a receipt writer, and it has a function to deliver information to the receipt writer such that the latter can write a receipt, and it has an order function that activates the receipt writer. Furthermore, the cash register comprises a data processing unit that can, for example, calculate the difference between the amount paid in and the requested amount.

The connection of a payment means management unit to a cash register is known. Such a payment means management unit may be, for example, in the form of a signal processing arrangement that is connected between a cash register and its receipt writer, as is described in SE 504 358. Such a signal processing arrangement comprises a buffer unit for the temporary storage of data. The aim of this invention is to achieve a payment means management unit that can be connected to different types of cash register without the need for modifying the cash register itself. The buffer unit cannot be used for any form of the permanent storage of data.

One problem with known cash registers is that it is relatively easy to “rig” them such that they print out receipts to customers despite the income not being recorded at all, being partially recorded, or being erroneously recorded. Business operators can in this way conceal their income from tax authorities, something that costs the government enormous amounts every year in the form of reduced tax revenue. Some form of control system is required in order to prevent this form of tax evasion.

The control systems that are currently used are based on sealing, in the same manner as tachographs. Either the cash register itself is sealed, or a type of separately sealed unit in which all transactions are stored is used. As long as the seal is not broken, it can be assumed that the information in the cash register or in the sealed unit is correct, but the information can be checked only through the cash register or the unit. There is for this reason a need for a control system in which the information can be checked by another method than through a sealed cash register or a sealed unit.

### SUMMARY OF THE INVENTION

The present invention concerns a control unit, a control system and a method for checking the transactions carried out by a cash register.

The present invention thus specifies a control unit with interfaces for connection to at least one cash register and at least one receipt writer, characterised in that the control unit comprises at least one regulatory unit in which encryption algorithms are stored, which encryption algorithms are used to generate a unique code, based on the transaction data that has been stored, which code is sent to the receipt writer to be written onto the receipt.

The control unit preferably comprises also at least one internal storage unit in which transaction data from the cash register is stored, and at least one further interface for connection to an external computer or to an external computer network. The control unit is preferably also arranged with an external protection, through it being designed, for example, as a sealed unit. The regulatory unit preferably comprises some form of programmable logic device, such as an FPGA (field programmable gate array). The encryption algorithm is preferably an asymmetric encryption method that uses keys, such as an RSA algorithm.

The present invention specifies also a control system for the checking of transactions carried out in at least one cash register, which control system comprises at least one cash register, at least one receipt writer, and at least one control unit, which control unit is connected through an interface to the said at least one cash register and at least one receipt writer, characterised in that the control unit comprises at least one regulatory unit in which encryption algorithms are stored, which encryption algorithms are used to generate a unique code, based on the transaction data that has been stored, which unique code is sent to the receipt writer to be written onto the receipt.

The present invention specifies also a method for the checking of transactions carried out in a cash register with the aid of a control unit, whereby the control unit is connected through interfaces to at least one cash register and at least one receipt writer, characterised in that the control unit comprises at least one regulatory unit in which encryption algorithms are stored, whereby the method comprises the steps: the transfer of transaction data from the cash register to the control unit through the interface; the use of the encryption algorithms to encrypt the transaction data such that a unique code is generated; the transfer of the unique code, together with the transaction data, to the receipt writer through the interface; and the printing on the receipt writer of a receipt that contains not only the transaction data but also the unique code.

The advantage is achieved through the control unit, control system and method for checking transactions carried out in a cash register described above that the authenticity of all receipts that are produced by the system can be checked without the need to read the information that is stored in the control unit. For the sake of simplicity, discount vouchers, credit notes and similar items are included in the concept of “receipts” comprised by this description and by these claims.

### BRIEF DESCRIPTION OF DRAWINGS

FIG. 1 shows a schematic drawing of a control system according to one embodiment of the invention.

FIG. 2 shows a schematic drawing of a control unit according to one embodiment of the invention that can be used in a control system according to FIG. 1.

### DESCRIPTION OF PREFERRED EMBODIMENTS

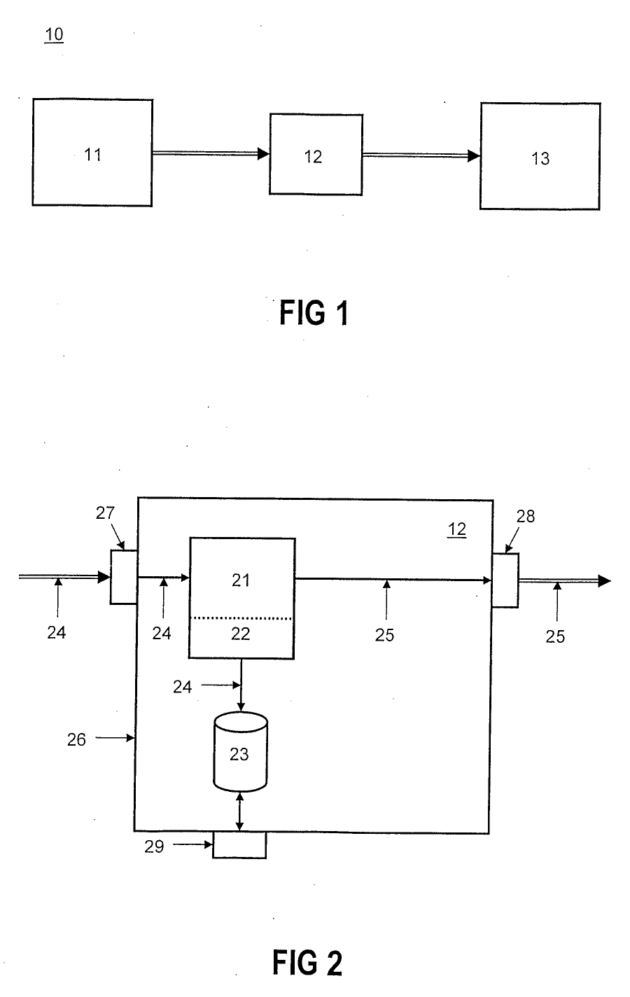

FIG. 1 shows a schematic drawing of a control system 10 according to one embodiment of the invention. The control system 10 consists of a cash register 11, a control unit 12 and a receipt writer 13. The control unit 12 is connected between the cash register 11 and the receipt writer 13 according to this embodiment, but other configurations are also possible. The control unit 12 can preferably be connected to known cash registers 11 and receipt writers 13, without the need for any adaptation of these.

FIG. 2 shows a schematic drawing of a control unit 12 according to one embodiment of the invention, which can be used in a control system 10 according to FIG. 1. The control unit 12 comprises a regulatory unit 21, in which encryption algorithms 22 are stored, and an internal storage unit 23. The control unit 12 has also interfaces 27, 28 designed in a suitable manner such that it can be connected to the cash register 11 and the receipt writer 13.

When a transaction is to be carried out, an operator inputs or scans in the prices of the goods or services that are to be purchased into the cash register 11, whereby the total amount requested is calculated. The transaction data 24 that is to be written on the receipt, which transaction data normally comprises not only identification of the cash register, but also date, time, requested amount, and amount tendered, is subsequently sent to the control unit 12, which receives the data through the interface 27. This transaction data 24 is subsequently sent to the regulatory unit 21 where it is encrypted with the aid of the encryption algorithm 22. All transaction data 24 is sent also to the internal storage unit 23 for storage, either in its encrypted or in its unprocessed form, or in both forms.

Modified transaction data 25, which comprises encrypted transaction data in the form of a code, original transaction data 24, and data that identifies the control unit 12, are subsequently sent through the interface 28 to the receipt writer 13 to be written onto the receipt. All receipts will thus contain a unique code. It will thus become possible through this encryption to check the authenticity of all receipts, discount vouchers, credit notes and similar that are produced by the control system 10.

The encryption may be designed in a number of different ways, for example in the form of encryption by the use of keys or a one-way encryption such as hash encryption. A number of different encryption algorithms can be used, such as RSA, Blowfish, Twofish, Serpent, SHA-1 or RIPEMD-160. The encryption according to one preferred embodiment, however, is an asymmetric encryption by the use of keys, where the encryption algorithm 22 preferably encrypts transaction data 24 that has been input by the use of an open or public encryption key. The code that is written onto the receipt can then be interpreted only by a person who has access to the secret or private paired key of the encryption algorithm 22. An asymmetric encryption method thus makes it possible to distribute the public key to any person from whom it is desired to be able to receive encrypted messages and to retain the private key for oneself. Once a message has been encrypted, it is impossible to decipher it without the private key. The public key is, in this case, no help at all.

The encryption according to one preferred embodiment is RSA/128, a 128-bits encryption using the RSA-algorithm of the same type as that used by many banks. The algorithm permits one-way encryption through the use of the mathematical assumption that a given algorithm in the form of an equation with one given term selected as an unknown is extremely difficult to solve. Prime-number factorisation of large integers is used in the case of RSA, which is mathematically very complex. Large numbers that are either primes or strong primes are combined as factors of the algorithm and thus constitute the private key. The combination can be published as the public key.

It is preferable that the control unit 12 has also at least one further interface 29 for connection to an external computer or external computer network, such that the contents of the internal storage unit 23 can be read. This reading can be carried out either by the direct connection of the control unit to a computer, or through an external computer network such as the Internet.

The control unit 21 can be designed in many ways, but it is preferable that it comprises some form or programmable logic device, for example an FPGA (field programmable gate array) or a PIC (programmed integrated circuit). The control unit comprises, however, according to one preferred embodiment, an FPGA in which the encryption algorithms 22 are stored. It is, in principle, impossible to read the information that is stored in an FPGA, and this makes it very difficult to by-pass the control system 10. It is preferable that the control unit 12 has also an outer protection 26, for example in the form of a sealed unit, in order to further increase the security.

A supervisory authority can, through the system described above, verify very easily the authenticity of a receipt by feeding the unique code that is on the receipt into the computer system of the authority, where the encrypted transaction data that is stored in the code can in this way be decrypted. This transaction data can subsequently be compared with the unencrypted transaction data that is on the receipt. If differences can then be detected, the supervisory authority can conclude that the receipt is a counterfeit.

The supervisory authority can use the control unit 12 also as a sealed unit for transaction data in the known manner. Reading of the storage unit 23 can then take place either directly, through the connection of the control unit 12 to a computer, or through an external network, such as the Internet. The information in the storage unit 23 that has been read can subsequently be compared with the transaction log kept by the business operator. The security of the system can be further increased if the stored transaction data is stored in the storage unit 23 solely in encrypted form, since this transaction data can then not be interpreted without access to the encryption key.

The invention has been described with embodiments in order to explain its principles and application, in order to make it possible for one skilled in the arts to realise the invention with suitable modifications within the framework of his or her competence. The scope of the invention is limited solely by the claims.

1. A control unit (12) with interfaces (27, 28) for connection to at least one cash register (11) and at least one receipt writer (13), characterised in that the control unit (12) comprises at least one regulatory unit (21) in which encryption algorithms (22) are stored, which encryption algorithms (22) are used to generate a unique code based on transaction data (24) from the cash register (11), which unique code is sent to the receipt writer (13) to be printed onto the receipt together with transaction data (24), whereby the authenticity of the receipt can be checked without the need to read the information that is stored in the control unit (12).

2. The control unit (12) according to claim 1, further comprising at least one internal storage unit (23) in which transaction data (24) from the cash register (11) is stored.

3. The control unit (12) according to claim 2, further comprising at least one further interface (29) for connection to an external computer or an external computer network.

4. The control unit (12) according to claim 1, which has been arranged with external protection (26), through its design, for example, as a sealed unit.

5. The control unit (12) according to claim 1, in which the regulatory unit (21) comprises some form of programmable logic device.

6. The control unit (12) according to claim 5, in which the regulatory unit (21) comprises an FPGA (field programmable gate array).

7. The control unit (12) according to claim 1, in which the encryption algorithm is an asymmetric encryption algorithm that uses keys.

8. The control unit (12) according to claim 7, in which the encryption algorithm is an RSA algorithm.

9. A control system (10) for checking transactions carried out in at least one cash register (11), which control system (10) comprises at least one cash register (11), at least one receipt writer (13), and at least one control unit (12), which control unit (12) is connected through interfaces (27, 28) to the said at least one cash register (11) and at least one receipt writer (13) characterised in that the control unit (12) comprises at least one regulatory unit (21) in which encryption algorithms (22) are stored, which encryption algorithms (22) are used to generate a unique code based on transaction data (24) from the cash register (11), which unique code is sent to the receipt writer (13) to be printed onto the receipt together with transaction data (24), whereby the authenticity of the receipt can be checked without the need to read the information that is stored in the control unit (12).

10. The control system (10) according to claim 9, in which the control unit (12) is a control unit further comprising at least one internal storage unit (23) in which transaction data (24) from the cash register (11) is stored.

11. A method for checking transactions carried out in a cash register (11) with the aid of a control unit (12), whereby the control unit (12) is connected through interfaces (27, 28) to at least one cash register (11) and at least one receipt writer (13) characterised in that the control unit (12) comprises at least one regulatory unit (21) in which encryption algorithms (22) are stored, whereby the method comprises the steps:
the transfer of transaction data (24) from the cash register (11) to the control unit (12) through the interface (27);
the use of the encryption algorithms (22) for encryption of transaction data (24) such that a unique code is generated;
the transfer of the unique code, together with transaction data (24), to the receipt writer (13) through the interface (28); and
the printing of a receipt in the receipt writer (13) comprising not only transaction data (24) but also the unique code, whereby the authenticity of the receipt can be checked without requiring reading of the information that is stored in the control unit (12).
